(19) United States
(12) Patent Application Publication
(10) Pub. No.: US 2015/0337638 A1
(43) Pub. Date: Nov. 26, 2015

(54) HYDROCARBON STIMULATION BY ENERGETIC CHEMISTRY

(71) Applicant: SANJEL CANADA LTD., Calgary (CA)

(72) Inventors: Sally LAWRENCE, Calgary (CA); Markus WEISSENBERGER, Calgary (CA)

(73) Assignee: SANJEL CANADA LTD., Calgary (CA)

(21) Appl. No.: 14/720,277

(22) Filed: May 22, 2015

Related U.S. Application Data
(60) Provisional application No. 62/002,342, filed on May 23, 2014.

(51) Int. Cl. E21B 43/24; C09K 8/90; C09K 8/84; C09K 8/80; E21B 43/267; E21B 43/26

(52) U.S. Cl. CPC E21B 43/2405; E21B 43/267; E21B 43/26; C09K 8/845; C09K 8/80; C09K 8/905

(57) ABSTRACT

Disclosed are methods and compositions for stimulating a hydrocarbon formation by generating heat and/or pressure in the formation, in either a fracturing or matrix treatment. This invention utilizes reactive fluids which comprise energetic chemistry that reacts in the formation to create heat and/or pressure. The heat may reduce the viscosity and increase the mobility of heavy oil, and/or the pressure may initiate or extend fractures in the hydrocarbon bearing formation. The reactive fluid may be buffered to slow the reaction and include an encapsulated activator to accelerate the reaction after suitable delay or when the fluid is placed in a zone of interest. Reactive fluids may be sequentially used, wherein each reactive fluid is successively less energetic than the preceding reactive fluid.

### FIELD OF THE INVENTION

The present invention relates to the use of exothermic chemical reactions to generate heat and/or pressure in a hydrocarbon bearing formation.

### BACKGROUND

An increasing world demand for oil and gas and increasing global oil pricing has made the exploitation of unconventional hydrocarbon resources economically attractive. Recovery of these resources, however, requires the use of stimulation techniques which can be costly and technically challenging. Stimulation is a treatment which is designed to enhance or restore productivity of hydrocarbons from a well which intersects a formation. Stimulation treatments generally fall into two main groups: hydraulic fracturing and matrix treatments. Fracturing treatments are performed above the fracture pressure of the subterranean formation to create or extend a highly permeable flow path between the formation and the wellbore. Matrix treatments are performed below the fracture pressure of the formation to improve flow or remove damage.

Many parts of North and South America are rich in heavy oils that can have viscosities in excess of 10,000 cPs. Steam injection techniques are often used to reduce the viscosity of such heavy oils. Steam injection, however, is a costly and inefficient process. The high heat capacity of water requires that large amounts of energy be added in order to create steam. Some of this energy is then lost to the surrounding formation, casing, and cement, making the process highly inefficient. The loss of energy to the wellbore cement and casing also places tremendous stresses on these materials due to thermal expansion and contraction, and requires the use of expensive thermal cements.

Hydraulic fracturing is a well-known stimulation technique that has been used to increase hydrocarbon recovery from conventional hydrocarbon reservoirs for decades. The advent of directional drilling and multi-stage fracturing techniques has allowed the expansion of this stimulation method to unconventional resources such as shale gas formations. Hydraulic fracturing of shale gas reservoirs is carried out using what is known as slickwaterfracturing and requires extremely high water volumes. Mounting pressure on water resources could jeopardize the industry's ability to exploit shale formations.

Methods of chemically generating heat down-hole are known, but the reactions do not always generate enough heat to significantly reduce heavy oil viscosity, nor do they generate sufficient pressure to fracture a formation. Further, the existing technology has no method of controlling the chemical reactions used and the exothermic reactions could begin during treatment placement, which is a significant safety hazard. Heat generation in the near wellbore can cause undesirable stresses in the well casing and cement, which could result in cement failure or vent flows to surface.

### SUMMARY OF THE INVENTION

This invention provides methods and compositions for stimulating hydrocarbon reservoirs by generating heat and/or pressure in the reservoir, in either a fracturing or matrix treatment. This invention utilizes reactive fluids which comprise energetic chemistry that reacts in the formation to create heat and/or pressure. The heat may reduce the viscosity and increase the mobility of heavy oil, and/or the pressure may initiate or extend fractures in the hydrocarbon bearing formation.

In one aspect, the invention comprises a method of stimulating a subterranean hydrocarbon formation penetrated by a wellbore, by injecting a reactive fluid comprising reactants which undergo exothermic and/or gas-generating reaction or reactions into the formation. In one embodiment, the reactive fluid comprises sufficient reactants to generate heat of at least about 100 kCal/liter of fluid, as calculated from known values, or measured empirically. The reactants may comprise sufficient concentrations of an ammonium compound and a nitrite compound.

In one embodiment, where the exothermic reaction is pH sensitive, the reactive fluid further comprises a stabilizing buffer solution, and an encapsulated acid activator. The encapsulated acid delays release of the acid until the reactive fluid is placed in a zone of interest. Upon release of the acid, the resulting lower pH allows the rate of reaction between the ammonium and nitrite ions to increase to a significant level. This reaction may also be initiated or accelerated by heat. The reaction generates heat and gas, which increases volume and builds pressure. In one embodiment, the reactive fluid further comprises ammonium nitrate. The exothermic reaction may generate sufficient heat to initiate the thermal decomposition of ammonium nitrate. The thermal decomposition of ammonium nitrate is also exothermic and generates additional heat and pressure.

Embodiments of this invention relate to methods of stimulating heavy oil formations by reducing the viscosity of the oil contained therein by heating the oil through the use of energetic chemical reactions. Other embodiments of the invention relate to methods of creating fractures in a hydrocarbon bearing formation by generating pressure using energetic chemical reactions.

In one embodiment, the reactive fluid may be used in addition to conventional fracturing pad and proppant stages. The reactive fluid may be placed at the tip of a fracture network created by a pad stage, and followed by one or more stages of proppant-laden fracturing fluids. By design, the encapsulated acid is not released until all or nearly all of the fracturing fluids have been pumped, and the fracture network closes. At that time, the reactive fluid reacts to generate heat and pressure, thereby extending the fracture network.

In one embodiment, the method of stimulation creates a reactive gradient, whereby heat and pressure in the zone proximal to the wellbore is lower than the heat and pressure created in a distal zone, outside the proximal zone. This reactive gradient may be achieved by pumping a first reactive fluid into the proximal zone, and displacing the first reactive fluid into the distal zone with a second reactive fluid, which is less energetic than the first reactive fluid. In some embodiments, additional reactive or non-reactive fluids may be used to push the first and second reactive fluids further away from the wellbore. For example, a third reactive fluid which is less energetic than the second reactive fluid may follow pumping of the second reactive fluid. The reactive gradient may be activated using an encapsulated acid in any of the reactive fluids, or by activating the most proximal reactive fluid. The heat generated by the most proximal reactive fluid may then activate more distal reactive fluids, thereby creating a heat plume to extend distally from the wellbore, with heat increasing from proximal to distal.

### BRIEF DESCRIPTION OF THE DRAWINGS

FIG. 1: Pressure and temperature increase when reaction is initiated using oxalic acid.

FIG. 2: Pressure and temperature increase when reaction is initiated using citric acid.

FIG. 3: Pressure and temperature increase when reaction is initiated using acetic acid.

FIG. 4 is a schematic diagram showing the proximal and distal placement of reactants.

### DETAILED DESCRIPTION

The invention relates to the stimulation of hydrocarbon-bearing formations, including conventional and unconventional formations. The reactions described herein provide a method of generating heat and pressure downhole in order to increase the productivity of an oil or gas well. Embodiments of the invention may mitigate the problems associated with existing stimulation methods, such as the inefficiency of steam generation or the large water volumes required for multi-stage hydraulic fracturing. Embodiments of the invention may also mitigate the problems associated with existing methods for generating energy downhole, that is insufficient heat and pressure generation, and/or the inability to control the exothermic reaction before the treatment has been properly placed.

Embodiments of the present invention use exothermic chemical reactions in a reactive treatment fluid, which may produce at least about 100 kCal per liter. For example, the reaction between the ammonium cation and the nitrite anion is strongly exothermic; the reaction between ammonium chloride and sodium nitrite releases 79.95 kCal/mol[1]

NH₄Cl+NaNO₂→N₂ (g)+NaCl+2H₂O+q (1)

Accordingly, approximately 1.25 M concentrations of these reactants has the measured or calculated capacity of producing 100 kCal per liter.

The rate of this reaction between ammonium and nitrite has been found to be highly pH dependent, with the rate of reaction significantly increasing as the activity of hydrogen ion in the solution increases. Hydrogen ion activity does not affect the mechanism of the reaction, however, the rate of reaction at pH 5 is approximately 138 times faster than at pH 7. The solution is therefore buffered to a pH of approximately 7 to prevent any significant reaction occurring before the stimulation treatment has been placed. It is known that the rate of reaction (1) is also dependent on temperature. The reaction rate follows the Arrhenius equation and has an activation energy of approximately 15 kCal/mol. Therefore, even at pH 7, the reaction will proceed if the solution is heated.

Once the treatment reactants have been placed, the reaction must be initiated by either heat or a protic acid, or both. In conventional prior art methods, the protic acid source is added with the reactants and could activate the reaction before the treatment has been placed in the formation. In embodiments of the present invention, the reactive fluid is buffered to stabilize the pH and prevent significant reaction occurring during pumping, and the acid activator is encapsulated to delay release until the reactive fluid has been placed in the desired zone.

The encapsulation of downhole reactants is well-known, and may include encapsulation coats comprising hydrated polysaccharides or other polymers, such asguar, chitosan, polyvinyl alcohol, carboxymethylcellulose, or xanthan. The encapsulation coat may be eroded or removed by aqueous dissolution, heat, mechanical pressure, or combinations thereof.

In one embodiment, the encapsulated acid activator may comprise an organic acid such as oxalic acid, citric acid or acetic acid. Without limitation to a theory, it is believed that organic acids with a lower pKa may perform better, and that a pKa below 4 may be preferred. Oxalic acid has a pKa of 1.27 while citric acid has a pKa of 3.14, both of which appeared to perform better in bench trials than acetic acid, with a pKa of 4.76. Inorganic acids such as hydrochloric acid may also be suitable as an activator.

In one embodiment, the purpose of the buffer is to ensure that the pH of the solution does not become acidic before activation or acceleration of the exothermic reactions is desired. The buffer may comprise small amounts of a strong or weak alkaline compound such as sodium or potassium hydroxide, sodium carbonate or pyridine, or combinations thereof.

Based on a specific heat capacity of water of 1 cal/g/° C., heating 1 m³ of water by 200° C. requires 200,000 kCal of energy, or approximately 2,500 moles of each reactant per m³ water. The concentration or quantity of reactants can be varied in order to control the amount of heat generated in the aqueous solution. The heat capacity and heat conductivity of the rock matrix at the point of treatment may also be significant factors to consider when designing the stimulation treatment.

In one embodiment, the source of ammonium ions in the reactive fluid may comprise, without limitation, ammonium chloride, ammonium sulphate, ammonium hydroxide, ammonium bromide, ammonium carbonate, urea, or ammonium nitrate. The source of nitrite ions may comprise, without limitation, sodium nitrite, or potassium nitrite. Specific embodiments of suitable ammonium/nitrite combinations include ammonium chloride/sodium nitrite or ammonium nitrate/sodium nitrite.

The reaction between ammonium and nitrite generates a large amount of energy, and may be used to generate sufficient energy to initiate the thermal decomposition of ammonium nitrate. The thermal decomposition of ammonium nitrate can take place through a number of different pathways depending on reaction conditions. Possible reaction pathways are shown in Reactions 2 to 6. All of these reaction pathways are exothermic, with each reaction pathway beginning with the endothermic step of the dissociation of ammonium nitrate into ammonia and nitric acid.²

NH₄NO₃→N₂O+2H₂O (2)

NH₄NO₃→3/4N₂+1/2NO₂+2H₂O (3)

NH₄NO₃→N₂+2H₂O+1/2O₂ (4)

8NH₄NO₃→5N₂+4NO+2NO₂+16H₂O (5)

NH₄NO₃→1/2N₂+NO+2H₂O (6)

In order to initiate the thermal decomposition of ammonium nitrate, it is believed that it is necessary that the temperature of the reactive mixture exceed 200° C. for a period of time. As can be seen in the above reactions, the thermal decomposition will result in the formation of oxides of nitrogen, including nitrogen dioxide (NO₂) gas. As the ammonium ions will react with nitrite, the reactive fluid must include enough ammonium nitrate to allow for the consumption of ammonium ions as well as to undergo thermal decomposition. As a result, in one embodiment, the reactive fluid may comprise greater than about 30%, 40%, or 50% ammonium nitrate (g/100 ml),

While generation of very high temperatures and pressures are desirable for the purpose of stimulating a hydrocarbon containing reservoir, such events cause huge stresses on wellbore casing and cement. These stresses can result in cement or casing failure, such as cracks or vent-flows to surface. It is therefore ideal to generate large amounts of heat into zones which are distal to the wellbore, while producing less heat in more proximal zones. This heat gradient stimulation may be achieved by sequential injections of less reactive or non-reactive fluids. A proximal zone of a wellbore is the volume of the formation which immediately surrounds the wellbore, where elevated heat and pressure may affect the integrity of the wellbore casing or cement. In one embodiment, the proximal zone may extend to about 3 m from the wellbore, preferably to about 4 meters, and more preferably to about 5 meters. The distal zone is the volume of the formation which surrounds the proximal zone.

In one embodiment, a first reactive fluid, which may be designed to achieve relatively higher levels of heat and/or pressure, is injected into the zone of interest. Then, a second less energetic fluid may be pumped to push the first reactive fluid distally, out of the proximal zone and into the distal zone. Optionally, a third reactive fluid, which may be less energetic than the second reactive fluid, may then be used to push both the second and first reactive fluids further away from the wellbore. The term “less energetic” means that the reactive fluid has a lower heat and/or pressure potential and may include a non-reactive fluid. The lower heat and pressure potential may be the result of having a lower concentration of reactants, different reactants with a lower heat of reaction, or a slower rate of reaction, or the absence of reactants.

The heat gradient stimulation system may be activated by including an encapsulated acid into any portion of the reactive fluids. Once the encapsulation dissolves or otherwise breaks, the acid accelerates the reaction between the ammonium and nitrite ions, and the generated heat may activate adjacent reactive fluids. If the encapsulated acid is included in the most proximal portion of the reactive fluid, the reactions will propagate outwards, eventually reaching the first reactive fluid.

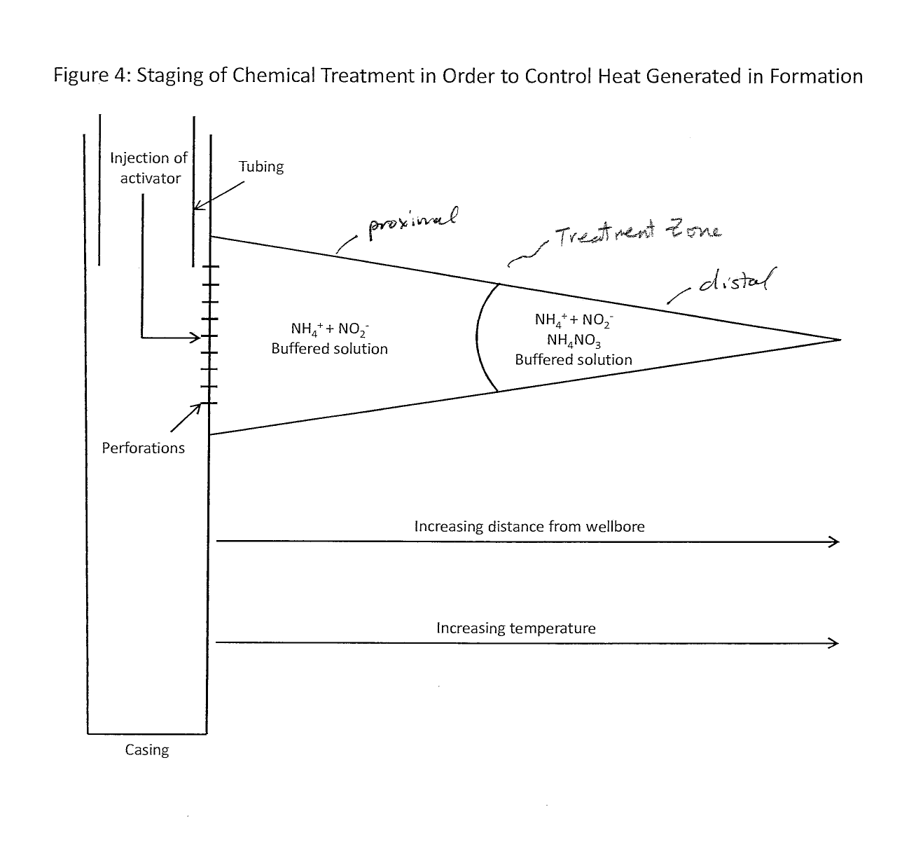

In an alternative embodiment, once the heat gradient stimulation system has been placed, an acid activator may then be added to the placed treatment. The acid accelerates the exothermic reaction between the ammonium and nitrite ions in the proximal zone, which then propagates outwards. A schematic of chemical placement is shown in FIG. 4. In this manner, the exothermic reactions are initiated after the treatment has been placed and there is no concern of significant reaction occurring prematurely during placement of a stimulation treatment, or in the event that a stimulation treatment is stalled for operational reasons. The staging of heat generation throughout the formation also mitigates concerns regarding cement or casing damage. This invention may therefore provide an advantage over current technology from the perspective of both safety and technical performance.

### EXAMPLE

The following examples are intended to illustrate specific embodiments of the claimed invention, and not to be limiting in any manner.

All laboratory reactions were carried out in a Parr Instruments 4590 Bench Top Reactor equipped with a 100 mL reactor vessel. Unless otherwise stated, initial pressure was 0 psi. The examples clearly show that this chemistry can be used to generate heat and pressure,

For safety reasons, the reactor was not filled with more than 33 mL of fluid, which limited the quantity of reactants in the reactive fluid. The temperature and pressure data presented below do not represent upper limits of the temperatures and pressures which may be achieved in field use.

### Example 1

### Variation of the Carboxylic Acid

18.5 g (0.231 mol) of ammonium nitrate was placed into a beaker; 17.05 g (0.95 mol) de-ionized water, 0.075 g (0.0007 mol) sodium carbonate, 0.15 g (0.0019 mol) pyridine, and 11.83 g (0.17 mol) sodium nitrite were added. The mixture was stirred on a magnetic stirrer until all solids were dissolved. The buffered reactive solution was added to the micro reactor vessel.

The reaction was initiated by lowering the pH from pH 7 to lower than pH 6. To enable an in-situ release of the acid inside the reactive solution, an encapsulated acid or a special release device could be used. Both methods allow the release of the acid at a certain temperature range, which depends on the properties of the release agent. To obtain the results below, a wax release device was used, which melted and released the acid as the system heated up.

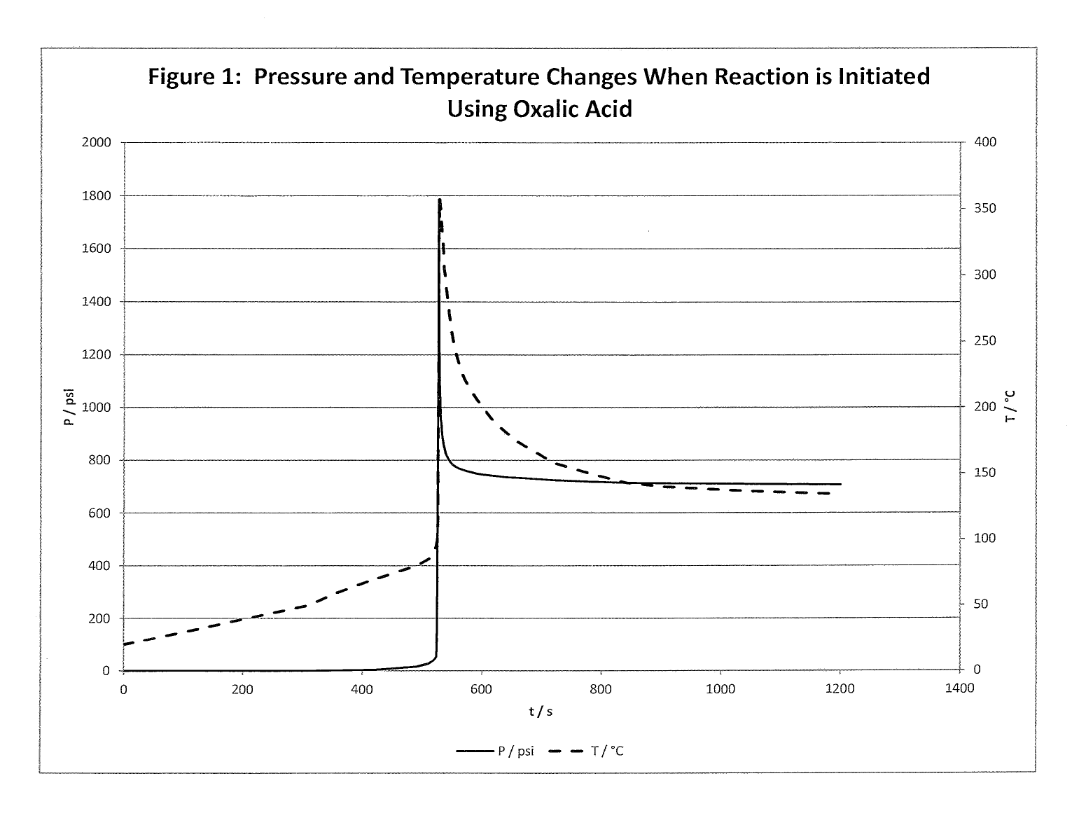

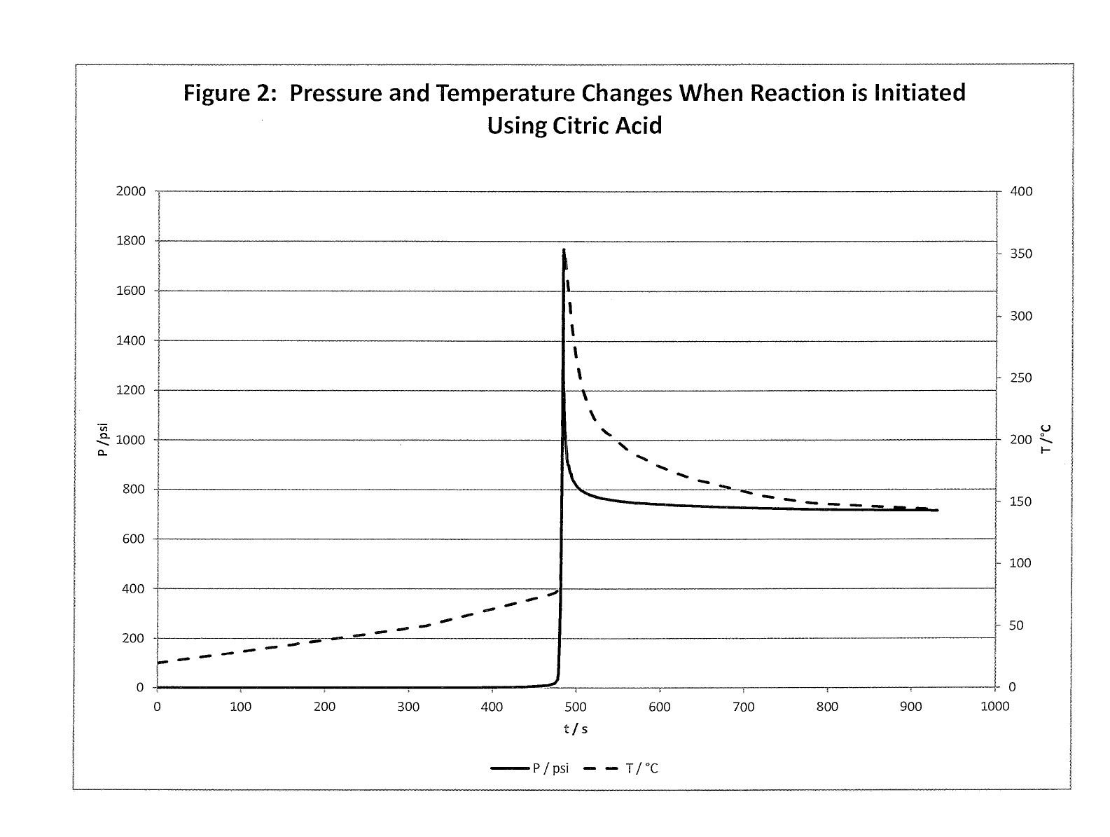

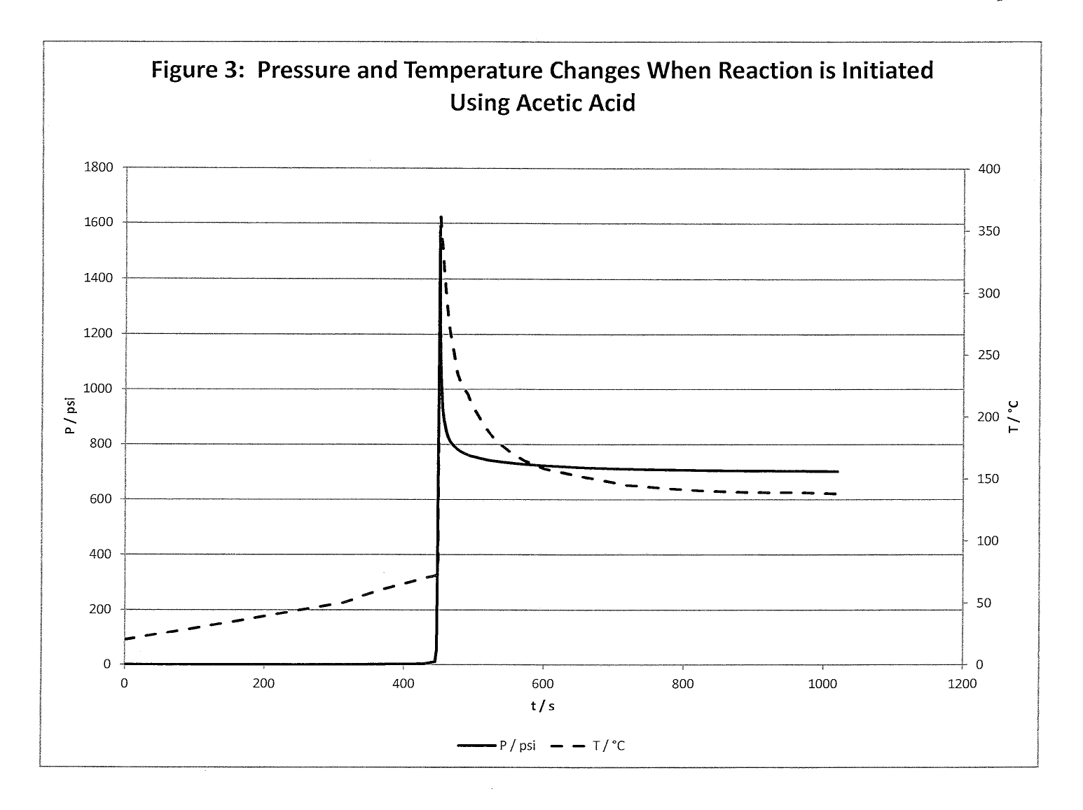

2 g of the organic acid (oxalic, citric or acetic) was placed into a wax release device and covered with 1 g of de-ionized water. The filled release device was placed gently inside the bottom of the micro reactor vessel and all valves were closed. The reaction vessel was positioned in the furnace and heated up to 75° C. The reaction starts after wax melts and the acid is released, which occurred between 60 and 75° C. A summary of the results is shown in Table 1 and graphed in FIGS. 1, 2 and 3.

TABLE 1
Temperature and Pressure Changes with Varying Carboxylic Acid

| | No | Max | Max | Final | Final |
|---|---|---|---|---|---|
| | Moles of | Temperature | Pressure | Temperature | Pressure |
| Acid | Acid | (° C.) | (psi) | (° C.) | (psi) |
| Oxalic | 0.016 | 359 | 1786 | 30 | 632 |
| Citric | 0.010 | 354 | 1744 | 46 | 654 |
| Acetic | 0.033 | 362 | 1570 | 42 | 643 |

### Example 2

### Effect of Initial Carboxylic Acid Concentration

18.5 g (0.231 mol) of ammonium nitrate was placed into a beaker; 17.05 g (0.95 mol) de-ionized water, 0.075 g (0.0007 mol) sodium carbonate, 0.15 g (0.0019 mol) pyridine, and 11.83 g (0.17 mol) sodium nitrite were added. The mixture was stirred on a magnetic stirrer until all solids were dissolved. The reactive solution was added to the micro reactor vessel.

The reaction was initiated by lowering the pH from pH 7, to lower than pH 6. To enable an in-situ release of the acid inside the reactive solution, an encapsulated acid or a special release device could be used. Both methods allow the release of the acid at a certain temperature range, which depends on the properties of the release agent.

The organic acid was placed into a wax release device and covered with 1 g of de-ionized water. The filled release device was placed gently inside the bottom part of the micro reactor vessel and all valves were closed. The reaction vessel was positioned in the furnace and heated up to 75° C. The reaction starts after the wax melts and the acid is released, usually between 60 and 75° C. A summary of the results is shown in Table 2.

TABLE 2
Temperature and Pressure Changes with
Varying Carboxylic Acid Concentration

| | No | Max | Max | Final | Final |
|---|---|---|---|---|---|
| | Moles of | Temperature | Pressure | Temperature | Pressure |
| Acid | Acid | (° C.) | (psi) | (° C.) | (psi) |
| Oxalic | 0.016 | 359 | 1786 | 30 | 632 |
| Oxalic | 0.008 | 373 | 1887 | 46 | 649 |
| Citric | 0.010 | 354 | 1744 | 46 | 654 |
| Citric | 0.0053 | 359 | 1721 | 42 | 639 |
| Acetic | 0.033 | 362 | 1570 | 42 | 643 |
| Acetic | 0.017 | 360 | 1573 | 49 | 623 |

### Example 3

### Effect of Reagent Ratios (Excess Ammonium Nitrate) in Varying Carboxylic Acids

Either 18.5 g (0.231 mol) or 14.84 g (0.185 mol) of ammonium nitrate was placed into a beaker; 17.05 g (0.95 mol) de-ionized water, 0.075 g (0.0007 mol) sodium carbonate, 0.15 g (0.0019 mol) pyridine, and 11.83 g (0.17 mol) sodium nitrite were added. The mixture was stirred on a magnetic stirrer until all solids were dissolved. The reactive solution was added to the micro reactor vessel,

The reaction was initiated by lowering the pH from pH 7 to lower than pH 6. To enable an in-situ release of the acid inside the reactive solution an encapsulated acid or a special release device could be used. Both methods allow the release of the acid at a certain temperature range, which depends on the properties of the release agent.

The organic acid was placed into a wax release device and covered with 1 g of de-ionized water. The filled release device was placed gently inside the bottom part of the micro reactor vessel and all valves were closed. The reaction vessel was positioned in the furnace and heated up to 75° C. The reaction starts after the acid is released, usually between 60 and 75° C. A summary of the results is shown in Table 3.

TABLE 3
Effect of Varying Ammonium Nitrate Concentration
on Temperature and Pressure

| | | Max | Max | Final | Final |
|---|---|---|---|---|---|
| | AN/SN | Temperature | Pressure | Temperature | Pressure |
| Acid | Ratio | (° C.) | (psi) | (° C.) | (psi) |
| Oxalic | 1.35:1 | 359 | 1786 | 30 | 632 |
| Oxalic | 1.1:1 | 363 | 1831 | 49 | 660 |
| Citric | 1.35:1 | 352 | 1744 | 46 | 654 |
| Citric | 1.1:1 | 360 | 1708 | 50 | 613 |
| Acetic | 1.35:1 | 362 | 1570 | 42 | 643 |
| Acetic | 1.1:1 | 359 | 1598 | 46 | 615 |

### Example 4

### Effect of Reagent Ratios (Varying Sodium Nitrite) with Hydrochloric Acid Initiator

14.84 g (0.185 mol) of ammonium nitrate was placed into a beaker; 17.05 g (0.95 mol) de-ionized water, 0.075 g (0.0007 mol) sodium carbonate, 0.15 g (0.0019 mol) pyridine, and varying amounts of sodium nitrite were added. The mixture was stirred on a magnetic stirrer until all solids were dissolved. The reactive solution was added to the micro reactor vessel.

The reaction was initiated by lowering the pH from pH 7 to lower than pH 6. To this end, hydrochloric acid (28%, 0.75 g in 4 g water) was added to the reaction vessel via a high pressure addition arm. The reaction vessel was not heated unless otherwise stated.

TABLE 4

| Mass of | | Max | Max | Final | Final |
|---|---|---|---|---|---|
| NaNO₂ | AN/SN | Temperature | Pressure | Temperature | Pressure |
| (g) | Ratio | (° C.) | (psi) | (° C.) | (psi) |
| 5.91 | 1:0.46 | 110* | 387 | 44 | 361 |
| 8.86 | 1:0.69 | 240# | 1100 | 40 | 488 |
| 14.78 | 1:1.15 | 200 | 1100 | 47 | 712 |
| 17.73 | 1:1.39 | 190 | 750 | 30 | 717 |

*The reaction was proceeding slowly under ambient conditions (ca. 250 psi, 35° C.) therefore the reaction vessel was heated to 95° C. in order to initiate a reaction
#The reaction was proceeding slowly under ambient conditions (ca. 250 psi, 35° C.) therefore the reaction vessel was heated 90° C. in order to initiate a reaction

### Example 5

### Effect of Temperature in Absence of Acid Initiator

14.84 g (0.185 mol) of ammonium nitrate was placed into a beaker; 17.075 g (0.948 mol) de-ionized water, and 11.82 g (0.17 mol) sodium nitrite was added. To one of the unbuffered solutions was also added 0.150 g (1.9×10⁻³ mol) pyridine and 0.075 g (7.08×10⁻⁴ mol) sodium carbonate. The mixture was stirred on a magnetic stirrer until all solids were dissolved. The reactive solution was added to the micro reactor vessel.

The reaction vessel was heated in 10° C. increments until the reaction began, as observed by an increase in pressure on the control unit. A summary of the results is shown in Table 5.

TABLE 5
Effect of Temperature on Reaction in Absence of Acid Initiator

| | Initial | Reaction | Max | Max | Final | Final |
|---|---|---|---|---|---|---|
| | Temperature | Heated To: | Temperature | Pressure | Temperature | Pressure |
| System | (° C.) | (° C.) | (° C.) | (psi) | (° C.) | (psi) |
| Unbuffered | 20 | 50 | 250 | 1600 | 97 | 626 |
| Buffered | 20 | 90 | 270 | 1600 | 21 | 382 |

### Example 6

### Effect of Mineral Acid vs. Carboxylic Acid

14.84 g (0.185 mol) of ammonium nitrate was placed into a beaker; 17.05 g (0.95 mol) de-ionized water, 0.075 g (0.0007 mol) sodium carbonate, 0.15 g (0.0019 mol) pyridine, and 8.86 g (0.127 mol) of sodium nitrite were added. The mixture was stirred on a magnetic stirrer until all solids were dissolved. The reactive solution was added to the micro reactor vessel. Hydrochloric acid was added via a high pressure addition arm; oxalic acid was added by a special wax release device.

TABLE 6

| | No | Max | Max | Final | Final |
|---|---|---|---|---|---|
| | Moles of | Temperature | Pressure | Temperature | Pressure |
| Acid | acid | (° C.) | (psi) | (° C.) | (psi) |
| Hydrochloric | 0.0058 | 240 | 1100 | 40 | 488 |
| Oxalic | 0.0058 | 322 | 990 | 46 | 456 |

### Example 7

### Heavy Oil Stimulation

A heavy oil field in the Lloydminster Sand in Alberta may be stimulated by reducing oil viscosity and thereby increasing oil mobility. The treatment zone is approximately 350 meters deep with a pay zone thickness of approximately 5 meters. The formation temperature is assumed to be approximately 20° C. and oil viscosity is 10,000 cPs with a recovery factor of approximately 8%. The intended goal of this stimulation treatment is to increase the temperature of the oil in order to decrease its viscosity and thereby increase the recovery factor from the well. The formation has a permeability of 1.0 to 1.5 Darcies and a porosity of 30%. The treatment zone is stimulated by squeezing reactive fluids into the zone at a rate such that the pressure remains lower than the frac gradient.

Service equipment was rigged in as per local regulations. Approximately 2 m³ (2 tubing volumes) formation compatible fluid was pumped through 2⅜″ tubing into the treatment zone to establish a feed rate and ensure that perforations were open and accepting fluid. A schematic depiction of the treatment zone is shown in FIG. 4.

A volume of a buffered first reactive fluid (pH 7) comprising ammonium chloride compound (3.0 M), sodium nitrite (3.0 M) and ammonium nitrate (6.0 M) was squeezed into the treatment zone. The first reactive fluid was displaced with a volume of a buffered second reactive fluid (pH 7) comprising ammonium chloride (3.0 M) and sodium nitrite (3.0 M), but not ammonium nitrate. This second reactive fluid was displaced with a volume of a third reactive fluid (buffered to pH 6) comprising ammonium chloride (2.0 M) and sodium nitrite (2.0 M), but not ammonium nitrate. This third reactive fluid was displaced with a volume of a fourth reactive fluid (buffered to pH 6) comprising ammonium chloride (1.0 M) and sodium nitrite (1.0 M). The volumes of the second, third and fourth reactive fluids to be used are substantially the same. The volume of the first reactive fluid to be used is approximately equal to the combined volume of the less reactive fluids. Table 7 shows calculated treatment zone volumes and reactive fluid volumes (assuming a conical homogenous treatment zone with 30% porosity). Table 8 shows calculated volumes based on a conical homogenous treatment zone with 6% porosity.

TABLE 7
Treatment volumes based on 30% porosity

| Estimated | Estimated | | |
|---|---|---|---|
| Treatment | Treatment | First | 2^{nd}, 3^{rd}, 4^{th} |
| Length | Zone Volume | Fluid Volume | Fluid Volume |
| (m) | (m³) | (m³) | (m³) |
| 5 | 118 | 39 | 39 |
| 10 | 471 | 157 | 157 |
| 20 | 1885 | 628 | 628 |
| 25 | 2945 | 982 | 982 |
| 50 | 11781 | 3927 | 3927 |
| 75 | 26507 | 8836 | 8836 |
| 100 | 47124 | 15708 | 15708 |

TABLE 8
Treatment volumes based on 6% porosity

| Estimated | Estimated | | |
|---|---|---|---|
| Treatment | Treatment | First | 2^{nd}, 3^{rd}, 4^{th} |
| Length | Zone Volume | Fluid Volume | Fluid Volume |
| (m) | (m³) | (m³) | (m³) |
| 5 | 24 | 8 | 8 |
| 10 | 94 | 31 | 31 |
| 20 | 377 | 126 | 126 |
| 25 | 589 | 196 | 196 |
| 50 | 2356 | 785 | 785 |
| 75 | 5301 | 1767 | 1767 |
| 100 | 9425 | 3142 | 3142 |

The above reactive fluids are then displaced into the reservoir with non-reactive formation compatible fluid. A hydrochloric acid activator fluid (8 litres of 15% HCl per cubic meter of 1 M reactive fluid to be activated) is circulated down the tubing and up the annulus with returns to surface until the face of the acid stage is above the perforations. Pumping is stopped and the annulus shut in.

The unencapsulated hydrochloric acid activator is then squeezed into the formation and displaced with a formation compatible fluid so that the hydrochloric acid activator contacts the fourth reactive fluid in a proximal zone, and accelerates the exothermic reaction between ammonium chloride and sodium nitrite. The heat generated in this reaction is sufficient to initiate a chain reaction in the more distal reactive fluids, such that in the first reactive fluid in the most distal zone, the thermal decomposition of ammonium nitrate is initiated.

The system volume significantly expands due to the temperature increase .⁵ This expansion causes the stimulation treatment to extend further into the formation. The oil contained in the formation is heated up, its viscosity reduced, and its mobility increased.

### Example 8

### Addition to Conventional Sand Fracturing Stimulation

A shallow gas formation may be stimulated by hydraulic fracturing. The treatment zone is approximately 350 meters deep with a pay zone of 10 meters thickness. The treatment zone has a recorded temperature of 27.3° C. and a fracture gradient of 22.0 kPa/m. The goal of this reactive fluid treatment is to extend a fracture network system created by conventional hydraulic fracturing techniques. Reactive fluids will be added between the traditional pad stage and the subsequent proppant stages. In this case, the acid activator is encapsulated in a physical coating, which either dissolves in the aqueous solution with time and/or temperature, or is mechanically broken and released by closing pressure of the fracture. Through the use of encapsulated activator, the reactive fluids will not substantially react until after the fracture network has closed. Once the activator activates the reaction, heat and pressure will be generated, subsequently extending the created fracture network.

Service equipment is rigged in as per local regulation. Approximately 15 m³ of formation compatible fracturing fluid (FCFF) is pumped from surface at a rate of 3 m³/minute down 88.9 mm diameter tubing into the formation. This fluid hydraulically fractures the formation.

This fracturing step is immediately followed by a 5 m³ volume of buffered reactive fluid (pH 7) comprising ammonium chloride (3.0 M), sodium nitrite (3.0 M) and ammonium nitrate (6.0 M). Encapsulated oxalic acid activator is added to this fluid in the ratio of 0.07 moles oxalic acid to 1 mole ammonium nitrate. The reactive fluid stage is then followed by conventional proppant laden fracturing fluid, in increments of 200 kg/m³ up to 1200 kg/m³ as per Table 9. The treatment was then flushed to the top of the perforation and the well was shut in. Service equipment was subsequently rigged out from the well.

TABLE 9
Pumping Schedule for Sand Fracturing Stimulation

| | | Clean | Clean | Prop | Stage | Prop |
|---|---|---|---|---|---|---|
| | Fluid | Stage | Cumm | Conc | Total | Cumm |
| Description | Type | (m³) | (m³) | (kg/m³) | (kg) | (kg) |
| PAD | FCFF | 15.0 | 0.0 | 0.0 | 0.0 | 0.0 |
| Reactive | Reactive | 5.0 | 5.0 | 0.0 | 0.0 | 0.0 |
| Fluid | Fluid | | | | | |
| Proppant | FCFF | 5.0 | 10.0 | 100.0 | 500.0 | 500.0 |
| Stage 1 | | | | | | |
| Proppant | FCFF | 5.0 | 15.0 | 200.0 | 1000.0 | 1500.0 |
| Stage 2 | | | | | | |
| Proppant | FCFF | 5.0 | 20.0 | 400.0 | 2000.0 | 3500.0 |
| Stage 3 | | | | | | |
| Proppant | FCFF | 5.0 | 25.0 | 600.0 | 3000.0 | 6500.0 |
| Stage 4 | | | | | | |
| Proppant | FCFF | 5.0 | 30.0 | 800.0 | 4000.0 | 10500.0 |
| Stage 5 | | | | | | |
| Proppant | FCFF | 5.0 | 35.0 | 1000.0 | 5000.0 | 15500.0 |
| Stage 6 | | | | | | |
| Proppant | FCFF | 3.8 | 38.8 | 1200.0 | 4500.0 | 20000.0 |
| Stage 7 | | | | | | |
| Flush | FCFF | 7.5 | 46.3 | 0.0 | 0.0 | 20000.0 |

Following all pumping stages, the reactive fluid is then in the tip of the fracture network. Upon the fracture network closing, the encapsulated activator is released, and accelerates the exothermic reaction between the ammonium chloride and sodium nitrite compounds. The heat generated in this reaction is sufficient to result in thermal decomposition of ammonium nitrate.

The thermal decomposition of ammonium nitrate yields sufficient heat and pressure. The system volume may expand by a significant factor. This expansion causes the fracture network to extend further into the formation.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments and examples were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

### REFERENCES

The following references are incorporated herein in their entirety, where permitted, and are indicative of the level of skill of one skilled in the art.
1. Nguyen, D. A., Iwaniw, M. A., Fogler, H. S., Chem Eng Sci, 58 (2003) 4351
2. Cagnina, S., Rotureau, P., Adamo, C., Chem Eng Transactions, Vol 31, 2013
3. The IAPWS Formulation 1995 for the Thermodynamic Properties of Ordinary Water Substance for General and Scientific Use
4. Ogunsola, O. M., Berkowitz, N., Fuel Processing Technology, 45 (1995) 95
5. Keenan & Keys, “Thermodynamic Properties of Steam”, John Wiley and Sons, New York
6. Al-Nakhli et al. PCT Application WO 2013/078306

What is claimed is:

1. A method of stimulating a subterranean hydrocarbon formation penetrated by a wellbore, the formation having a proximal zone adjacent the wellbore, and a distal zone outside the proximal zone, the method comprising:
(a) injecting a first reactive fluid comprising exothermic reactants into the proximal zone;
(b) displacing the first reactive fluid into the distal zone with a second reactive fluid, which is less energetic than the first reactive fluid; and
(c) activating the second reactive fluid such that heat generated by the second reactive fluid activates the first reactive fluid.

2. The method of claim 1 wherein the second reactive fluid is less energetic than the first reactive fluid as a result of a lower concentration or quantity of reactants, or the absence of ammonium nitrate, or both.

3. The method of claim 1 wherein the first reactive fluid comprises an ammonium compound and a nitrite compound.

4. The method of claim 3 wherein the first reactive fluid comprises ammonium nitrate in addition to the ammonium compound.

5. The method of claim 1 comprising the further step of displacing the first and second reactive fluids with at least one additional reactive fluid which is less reactive than the second reactive fluid, and activating the at least one additional reactive fluid such that heat generated by the at least one additional reactive fluid activates the second reactive fluid.

6. The method of claim 1 wherein the ammonium nitrate is present in the first reactive fluid in a concentration greater than about 30%.

7. The method of claim 4 wherein the ammonium nitrate is present in the first reactive fluid in a concentration greater than about 40%.

8. The method of claim 4 wherein the ammonium nitrate is present in the first reactive fluid in a concentration greater than about 50%.

9. The method of claim 3 wherein the nitrite compound is sodium nitrite.

10. The method of claim 3 wherein the ammonium compound is ammonium chloride.

11. The method of claim 3 wherein the second reactive fluid is buffered to a neutral pH and comprises an encapsulated activator acid.

12. A method of stimulating a subterranean hydrocarbon formation penetrated by a wellbore, the formation having a treatment zone, the method comprising:
(a) injecting a buffered reactive fluid comprising an ammonium compound, a nitrite compound, an encapsulated acid into the treatment zone;
(b) wherein the encapsulated acid is configured to release the acid once the reactive fluid has been placed into the treatment zone.

13. The method of claim 3 wherein the reactive fluid is placed at the tip of a fracture network created by a conventional fracturing step, and followed by at least one stage of proppant laden fracturing fluid.

14. The method of claim 12 wherein the encapsulated acid is broken and released by the closing force of the fracture network, or by dissolving over time or with increased temperature.

15. The method of claim 12 wherein the reactive fluid comprises ammonium nitrate in a concentration greater than about 30%.

16. The method of claim 15 wherein ammonium nitrate is present in the reactive fluid in a concentration greater than about 40%.

17. The method of claim 16 wherein the ammonium nitrate is present in the reactive fluid in a concentration greater than about 50%.

18. A stimulation reactive fluid comprising reactants which undergo exothermic and/or gas-generating reaction or reactions into the formation, a neutral pH buffer comprising an alkaline substance, and an encapsulated acid activator, wherein release of the activator increases the rate of the exothermic and/or gas generating reaction or reactions.

19. The stimulation reactive fluid of claim 18 wherein the activator comprises an organic acid encapsulated in a polymer.

20. The stimulation reactive fluid of claim 19 wherein the polymer comprises one of guar, chitosan, polyvinyl alcohol, carboxymethylcellulose or xanthan.
